(19) United States
(12) Patent Application Publication
(10) Pub. No.: US 2020/0087808 A1
(43) Pub. Date: Mar. 19, 2020

(54) METHOD OF ELECTROFORMING MICROSTRUCTURED ARTICLES

(71) Applicant: 3M INNOVATIVE PROPERTIES COMPANY, St. Paul, MN (US)

(72) Inventors: Barry S. Carpenter, Oakdale, MN (US); Jeremy K. Larsen, Farmington, MN (US); Brian K. Nelson, Shoreview, MN (US); Scott M. Schnobrich, Stillwater, MN (US); Stephen J. Znameroski, Eagan, MN (US)

(21) Appl. No.: 16/470,332

(22) PCT Filed: Dec. 21, 2017
(86) PCT No.: PCT/IB2017/058299

§ 371 Date: Jun. 17, 2019

Related U.S. Application Data
(60) Provisional application No. 62/438,567, filed on Dec. 23, 2016.

(51) Int. Cl. C25D 1/08; F02M 61/18

(52) U.S. Cl. CPC C25D 1/08; F02M 61/18

(57) ABSTRACT

Methods of electroforming fuel injector nozzle structures such as, e.g., nozzle plates, valve guides, combinations of nozzle plates and valve guides, etc., as well as other articles incorporating microstructured features. The methods described herein can be used to electroform articles with high aspect ratio features in close proximity while reducing the likelihood of void formation during the electroforming process.

### RELATED APPLICATIONS

The methods of manufacturing nozzle structures as discussed herein may be, in one or more embodiments, used in combination with the methods of manufacturing nozzle structures as discussed in and/or the nozzle structures described in the following co-pending applications: MAKING NOZZLE STRUCTURES ON A STRUCTURED SURFACE, U.S. Provisional Application No. 62/438,561, filed on Dec. 23, 2016 (Attorney Docket No. 77312US002) and NOZZLE STRUCTURES WITH THIN WELDING RINGS AND FUEL INJECTORS USING THE SAME, U.S. Provisional Application No. 62/438,558, filed on Dec. 23, 2016 (Attorney Docket No. 77311US002).

### FIELD OF THE INVENTION

This invention generally relates to methods of electroforming nozzle structures (e.g., nozzle plates, valve guides, other nozzle structures, and combinations thereof that can be suitable for use in a fuel injector for an internal combustion engine), as well as other articles including microstructured features.

### BACKGROUND

There are three basic types of fuel injector systems: port fuel injection (PFI), gasoline direct injection (GDI), and direct injection (DI). While PFI and GDI use gasoline as the fuel, DI uses diesel fuel. Efforts continue to further develop methods of manufacturing fuel injector nozzle structures (e.g., nozzle plates, otherwise known as director plates) and fuel injection systems containing the same so as to potentially increase fuel efficiency and reduce hazardous emissions of internal combustion engines, as well as reduce the overall energy requirements of a vehicle comprising an internal combustion engine.

The fuel injector systems use fuel injector nozzles including nozzle structures with through-holes to deliver fuel for combustion. Manufacturing of the nozzle structures can pose particular challenges in systems where control over the delivery of the fuel through the nozzle structures can improve or reduce efficiency of the engines.

### SUMMARY

The present invention is directed to methods of electroforming fuel injector nozzle structures such as, e.g., nozzle plates, valve guide structure, combinations of nozzle plate and valve guide structure, etc., as well as other articles incorporating microstructured features.

In one or more embodiments, the methods described herein can be used to electroform articles with high aspect ratio features in close proximity while reducing the likelihood of void formation during the electroforming process. Typically, the surfaces of structures to be electroformed are coated with a metal (e.g., silver or other conductive metal) coating to make the surface conductive—including vertical surfaces on high aspect ratio features. Referring to, e.g., FIG. 1, an article 10 including a microstructured pattern 30 on a base surface 12 is depicted. The microstructured pattern 30 includes microstructured features 40, each of which includes a base 42 on the base surface 12 and a distal end 44 located distal from the base 42 and the base surface 12. Also depicted in FIG. 1, an electrically conductive coating 20 is located on the base surface 12 as well as the microstructured features 40. In particular, the electrically conductive coating 20 is located on the vertical surfaces of the microstructured features 40 as well as on the distal ends 44.

Electroforming a metal structure (e.g., in the form of a plate) on the microstructured article 10 as depicted in FIG. 2 results in the electroformed metal 50 being deposited on every conductive surface covered by electrically conductive coating 20. As a result, even the vertical surfaces of the microstructured features 40 are coated with electroformed metal 50. Typically, in situations in which the microstructured features have a relatively high aspect ratio (i.e., are located close to each other relative to their height above the base surface), the electroformed metal 50 deposited on the vertical surfaces of high aspect ratio microstructured features 40 meets near the distal ends 44 of the microstructured features 40 before the inter-feature space between the microstructured features 40 is completely filled with the electroformed metal 50. As a result, voids 52 can be formed near the bases 42 of the microstructured features 40.

Voids in electroformed articles, such as, e.g., voids 52, are potential structural weak points in electroformed articles, and can lead to failure when the article is stressed either with temperature, pressure, or both. These problems may be particularly true when the electroformed articles are nozzle structures for use in fuel injection nozzles which are typically subjected to relatively high temperature and pressure during use. Reducing the likelihood of void formation can improve the durability of electroformed articles including microstructured features as described herein.

In one or more embodiments, methods of electroforming articles (such as, e.g., nozzle structures) as described herein comprise: forming a microstructured pattern of a first material, wherein the microstructured pattern comprises a plurality of microstructured features extending away from a base surface, wherein each microstructured feature of the plurality of microstructured features comprises a base proximate the base surface and a distal end located distal from the base surface, wherein the base surface is an electrically conductive surface, each microstructured feature has a non-uniform cross-section along its length and an electrically non-conductive surface between its base and distal end, wherein the plurality of microstructured features of the microstructured pattern are (i) discrete from each other, (ii) connected to each other, or (iii) a combination of both (i) and (ii); electroforming a metal structure (e.g., in the form of a plate) from the base surface after forming the microstructured pattern, wherein the metal structure extends away from the base surface and conforms to the electrically non-conductive surface of each microstructured feature; and removing the first material from the metal structure to make a microstructured metallic article comprising a negative of the microstructured pattern in the metal structure.

In one or more embodiments, the plurality of microstructured features comprises a pair of neighboring microstructured features comprising a first microstructure and a second microstructure, wherein a distance between the first microstructure and the second microstructure changes when moving in a direction away from the base surface towards the distal ends of the first and second microstructured features. In one or more embodiments, the distance increases. In one or more embodiments, the distance decreases. In one or more embodiments, the distance increases and decreases when moving in a direction away from the base surface towards the distal ends of the first and second microstructured features.

In one or more embodiments, the base of each microstructure of the plurality of microstructured features is completely surrounded by the electrically conductive base surface.

In one or more embodiments, the bases of the pair of neighboring microstructured features contact each other such that the base of neither microstructure of the pair of neighboring microstructured features is completely surrounded by the electrically conductive base surface.

In one or more embodiments, the plurality of microstructured features comprises three or more microstructured features, and wherein at least one microstructure of the three or more microstructured features comprises a base in contact with the bases of at least two microstructured features such that the base of at least one microstructure is not completely surrounded by the electrically conductive base surface.

In one or more embodiments, an entire surface of each microstructure of the plurality of microstructured features is electrically non-conductive.

In one or more embodiments, the base surface comprises an electrically conductive layer.

In one or more embodiments, a height of each microstructure of the plurality of microstructured features above the base surface is 2 millimeters or less.

In one or more embodiments, the microstructured metallic article comprises first and second major surfaces on opposite sides of the microstructured metallic article, wherein the microstructured metallic article comprises a plurality of through-holes extending from the first major surface to the second major surface, wherein each through-hole comprises a first opening on the first major surface and a second opening on the second major surface, and wherein each through-hole of the plurality of through-holes and its first and second openings have a shape defined by one microstructure of the plurality of microstructured features.

In one or more embodiments, forming the microstructured pattern of the first material comprises providing an amount (e.g., a layer or thickness) of the first material over the base surface followed by using a multiphoton process on the first material.

In a second aspect, one or more embodiments of methods of fabricating a microstructured metallic article as described herein may include: positioning an electrically conductive surface of a molding insert against a first major surface of a microstructured mold, wherein the microstructured mold comprises a second major surface on an opposite side of the microstructured mold from the first major surface, wherein the microstructured metallic mold comprises a plurality of cavities located therein, wherein each cavity of the plurality of cavities comprises a first opening on the first major surface, wherein the molding insert comprises a plurality of apertures, wherein each aperture of the plurality of apertures is aligned with a first opening of one of the cavities in the microstructured mold; delivering molding material into each cavity of the plurality of cavities of the microstructured mold; separating the microstructured mold from the molding material and the molding insert after delivering molding material into each cavity of the plurality of cavities of the microstructured mold, wherein the molding material forms a microstructured pattern comprising a plurality of microstructured features extending away from the electrically conductive surface of the molding insert, wherein each microstructured feature of the plurality of microstructured features comprises a base proximate the electrically conductive surface of the molding insert and a distal end located distal from the electrically conductive surface of the molding insert, and wherein each microstructured feature has an electrically non-conductive surface between its base and distal end; electroforming a metal structure (e.g., in the form of a plate) on the electrically conductive surface of the molding insert after separating the microstructured mold from the molding material and the molding insert, wherein the metal structure extends away from the electrically conductive surface of the molding insert and conforms to the electrically non-conductive surface of each microstructured feature; and removing the molding material from the metal structure to make a microstructured metallic article comprising a negative of the microstructured pattern in the metal structure.

In one or more embodiments of methods according to the second aspect, each microstructured feature of the plurality of microstructured features comprises a non-uniform cross-section along its length, wherein the plurality of microstructured features of the microstructured pattern are (i) discrete from each other, (ii) connected to each other, or (iii) a combination of both (i) and (ii).

The above summary is not intended to describe each embodiment or every implementation of the methods of manufacturing nozzle structures or other articles as described herein. Rather, a more complete understanding of the invention will become apparent and appreciated by reference to the following Detailed Description and claims in view of the accompanying figures of the drawing.

### BRIEF DESCRIPTIONS OF THE DRAWINGS

FIG.1 is a cross-sectional view of one exemplary micro-structured article including micro-structured features with a high aspect ratio.

FIG. 2 is a cross-sectional view of the micro-structured article of FIG. 1 after electroforming a metal structure (e.g., in the form of a plate) thereon.

FIG. 3 is a cross-sectional view of a first material on a substrate including both an electrically conductive layer and an intermediate layer, with the intermediate layer located between the first material and the electrically conductive layer.

FIG. 4 is a cross-sectional view of one exemplary embodiment of a micro-structured pattern formed in the first material of FIG. 1, with the first material that does not form a part of the micro-structured pattern having been removed from the substrate.

FIG. 5 is a top view of the micro-structured pattern depicted in FIG. 4.

FIGS. 6A-6D are cross-sectional views of exemplary methods of forming a microstructured metallic article using microstructured patterns as depicted in FIGS. 4 and 5.

FIGS. 7A-7E are cross-sectional views of alternative embodiments of microstructure patterns which may be formed in the methods described herein.

FIGS. 8A-8B are top views of exemplary alternative arrangements of microstructured features located on an electrically conductive surface in one or more methods as described herein.

FIG. 9 is a cross-sectional view of another alternative embodiment of a micro-structured pattern located on an intermediate layer covering a conductive layer on a base surface.

FIG. 10 is a cross-sectional view of the micro-structured pattern of FIG. 9 after removal of a portion of the intermediate layer located between the micro-structured features of the microstructure to pattern.

FIG. 11 is a cross-sectional view of the micro-structured pattern of FIG. 10 after formation of an electroformed metal structure (e.g., in the form of a plate) over the micro-structured pattern.

FIG. 12 is a cross-sectional view of the micro-structured pattern of FIG. 11 after removal of a portion of the electroformed metal structure.

FIG. 13 is a cross-sectional view of the electroformed metal structure of FIG. 12 after removal of the conductive layer, the base on which the conductive layer was located and the first material forming the micro-structured features of FIG. 12.

FIG. 14 is one exemplary embodiment of a molding insert which may be used in one or more methods of electroforming micro-structured articles as described herein.

FIG. 15 is a cross-sectional view of the molding insert of FIG. 14 attached to a mold having a plurality of cavities located therein for forming micro-structured features of a microstructure pattern.

FIG. 16 is a cross-sectional view of the mold and molding insert of FIG. 15 after delivery of a first material into the cavities of the molding insert.

FIG. 17 is a cross-sectional view of the mold and molding insert of FIG. 16 after removal of the mold.

FIG. 18 is a cross-sectional view of the molding insert and micro-structured features of FIG. 17 after electroforming a metal structure (e.g., in the form of a plate) on the molding insert over the micro-structured features.

FIG. 19 is a cross-sectional view of the molding insert, micro-structured features, and electroformed metal structure of FIG. 18 after removal of a portion of the metal structure.

FIG. 20 is a cross-sectional view of the electroformed metal structure of FIG. 19 with the molding insert attached thereto.

FIG. 21 is a cross-sectional view of the electroformed metal structure of FIG. 20 after removal of the molding insert.

### DETAILED DESCRIPTION

In the following description, reference is made to the accompanying figures of the drawing which form a part hereof, and in which are shown, by way of illustration, specific embodiments. It is to be understood that other embodiments may be utilized and changes may be made without departing from the scope of the present invention.

The methods of manufacturing micro-structured articles (such as, e.g., nozzle structures) as described herein can, in one or more embodiments, use multiphoton (e.g., two photon) techniques, equipment and materials described in U.S. Pat. No. 9,333,598 B2 and US Patent Application Publication No. US 2013/0313339 (both titled “Nozzle and Method of Making Same”). In particular, multiphoton processes can be used to fabricate various microstructured patterns, which can, for example, include one or more hole forming features that may be used in, e.g., one or more nozzle structures used in fuel injectors. Further, the processes can, as described herein, be used to form nozzle structures (or other microstructured articles) themselves and/or as molds that can then be used to fabricate nozzle structures or other microstructured articles.

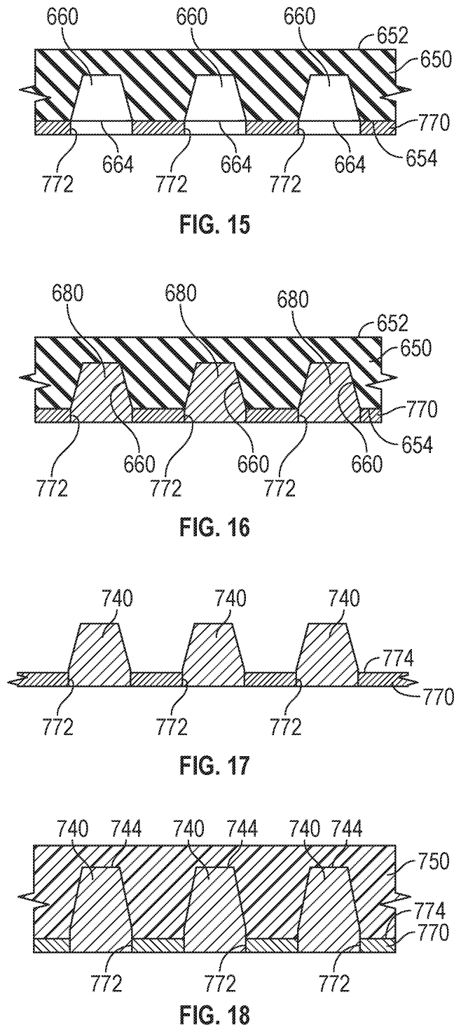

The microstructured articles described herein may, in one or more embodiments, be suitable for use as nozzle structures (including, e.g., nozzle plates, nozzle plate and valve guide structures, and other structural combinations) used in fuel injector nozzles. It should be understood that the term “nozzle” or “nozzle structure”, as used herein, may have a number of different meanings in the art. For example, U.S. Patent Publication No. 2009/0308953 A1 (Palestrant et al.), discloses an “atomizing nozzle” which includes a number of elements, including an orifice insert 24 and an occluder chamber 50. The understanding and definition of “nozzle structure” put forth herewith may, for example, include such structure like the orifice insert 24 of Palestrant et al. along with a portion, most or all of the structure corresponding to the chamber 50. In general, the nozzle structure of the current description can be understood as including the structure of an atomizing spray system from which the spray is ultimately emitted, see e.g., Merriam Webster's dictionary definition of nozzle (“a short tube with a taper or constriction used (as on a hose) to speed up or direct a flow of fluid.” Further understanding may be gained by reference to U.S. Pat. No. 5,716,009 (Ogihara et al.) issued to Nippondenso Co., Ltd. (Kariya, Japan). In this reference, again, fluid injection “nozzle” is defined broadly as the multi-piece valve element 10 (“fuel injection valve 10 acting as fluid injection nozzle . . .” —see col. 4, lines 26-27 of Ogihara et al.). The current definition and understanding of the term “nozzle structure” as used herein would relate, e.g., to first and second orifice plates 130 and 132, valve body 26, and potentially sleeve 138 (see FIGS. 14 and 15 of Ogihara et al.), for example, which are located immediately proximate the fuel spray. Similar structures that may be referred to as “nozzle structure”, as described herein, is disclosed in U.S. Pat. No. 5,127,156 (Yokoyama et al.) to Hitachi, Ltd. (Ibaraki, Japan). There, the nozzle 10 is defined separately from elements of the attached and integrated structure, such as “swirler” 12 (see FIG. 1). Such separate elements may be formed, in part or completely, as one unitary structure. The above-described structures may be included when the term “nozzle structure” is referred to throughout the remainder of the description and claims.

In one or more embodiments, nozzle structures manufactured using the methods described herein may include one or more nozzle through-holes strategically incorporated into the nozzle structure. The one or more nozzle through-holes may provide one or more of the following properties to the nozzle structure: (1) the ability to provide variable fluid flow through the nozzle (e.g., by opening or closing off one or more one or more nozzle through-holes), (2) the ability to provide multi- directional fluid flow relative to an outlet face of the nozzle structure, and (3) the ability to provide multidirectional off-axis fluid flow relative to a central normal line extending perpendicularly through the nozzle outlet face.

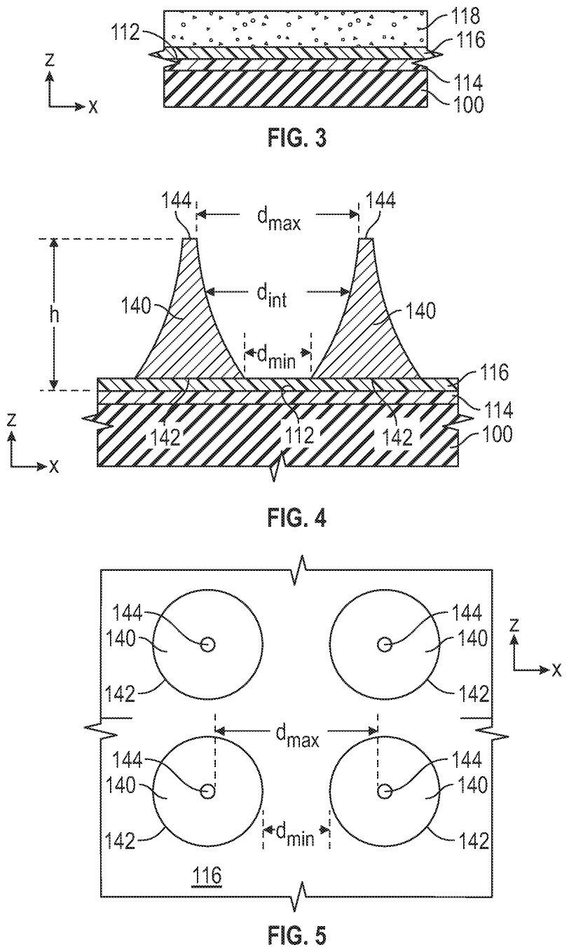

One embodiment of an illustrative method as described herein begins with formation of a microstructured pattern in material located on a substrate. FIG. 3 is a schematic side-view of a first material 118 disposed on a substrate 100 having a base surface 112 formed by an electrically conductive layer 114. An intermediate layer 116 may be provided over the base surface 112 formed by the electrically conductive layer 114 with the first material 118 located on the intermediate layer 116. In one or more embodiments, where, for example, the substrate 100 is itself electrically conductive, a separate electrically conductive layer 114 may not be required and the base surface 112 may be formed directly on the substrate 100—in such embodiments, the electrically conductive layer 114 is optional. The optional electrically conductive layer 114 may, in one or more embodiments, be formed of one or more metals or other conductive materials suitable for use as a surface on which electroformed metal can be deposited. Examples include, but are not limited to, elemental or alloyed metals (e.g., Ni, Co, and alloys that include one or both of these metals).

In one or more alternative embodiments, an electrically conductive layer 114 may also promote adhesion of microstructured features to a substrate that is already electrically conductive (i.e., improved adhesion as compared to adhesion provided by the materials forming the conductive substrate). Examples of such materials could include, e.g., titanium, indium tin oxide, etc.

Further, in one or more embodiments, the intermediate layer 116 may be optional. The optional intermediate layer 116 may, in one or more embodiments, be provided to improve attachment of the microstructrured features 140 to the base surface 112 formed by the electrically conductive layer 114 or to a base surface 112 formed directly on the substrate 100 when the substrate 100 is, itself, electrically conductive.

The intermediate layer 116 may, in one or more embodiments of the methods described herein, be selectively removable from those portions of the base surface 112 that are not located beneath the microstructured features 140 of a microstructured pattern formed on the base surface 112, particularly when the material used for the intermediate layer 116 is not electrically conductive enough for electroplating.

In one or more embodiments of the methods described herein the first material 118 in which the microstructured pattern is formed is capable of undergoing multiphoton reaction by simultaneously absorbing multiple photons. For example, in one or more embodiments, the first material is capable of undergoing a two photon reaction by simultaneously absorbing two photons. The first material can be any material or material system that is capable of undergoing multiphoton, such as two photon, reaction, such as those described in U.S. Pat. No. 7,583,444 (“Process For Making Microlens Arrays And Masteroforms”); U.S. Patent Application Publication US 2009/0175050 (“Process For Making Light Guides With Extraction Structures And Light Guides Produced Thereby”); and PCT Publication WO 2009/048705 (“Highly Functional Multiphoton Curable Reactive Species”).

In some cases, the first material can be a photoreactive composition that includes at least one reactive species that is capable of undergoing an acid- or radical-initiated chemical reaction, and at least one multiphoton photoinitiator system. Reactive species suitable for use in the photoreactive compositions include both curable and non-curable species. Exemplary curable species include addition-polymerizable monomers and oligomers and addition-crosslinkable polymers (such as free-radically polymerizable or crosslinkable ethylenically-unsaturated species including, for example, acrylates, methacrylates, and certain vinyl compounds such as styrenes), as well as cationically-polymerizable monomers and oligomers and cationically-crosslinkable polymers (which species are most commonly acid-initiated and which include, for example, epoxies, vinyl ethers, cyanate esters, etc.), and the like, and mixtures thereof. Exemplary non-curable species include reactive polymers whose solubility can be increased upon acid- or radical-induced reaction. Such reactive polymers include, for example, aqueous insoluble polymers bearing ester groups that can be converted by photogenerated acid to aqueous soluble acid groups (for example, poly(4-tert-butoxycarbonyloxystyrene). Non-curable species also include the chemically-amplified photoresists.

The multiphoton photoinitiator system enables polymerization to be confined or limited to the focal region of a focused beam of light used to expose the first material. Such a system preferably is a two- or three-component system that includes at least one multiphoton photosensitizer, at least one photoinitiator (or electron acceptor), and, optionally, at least one electron donor.

Examples of potentially suitable non-conductive materials for the optional intermediate layer 116 that improve attachment of the microstructured features 140 to the base surface 112 may include, but are not limited to, one or more nonconductive oxides or nitrides (with, e.g., materials with electrical conductivity too low for effective electroforming such as, e.g., titanium dioxide, titanium nitride, aluminum oxide, aluminum nitride, silicon dioxide, silicon nitride, etc.). Other materials that could be used as the intermediate layer 116 may include polymeric materials of similar composition to the first material 118 and can be used as an adhesion promoter. Silane materials may be desirable as such an adhesion promoter. Such intermediate layer materials could be deposited onto the substrate (via, e.g., sputter coating, physical vapor deposition, etc.) to promote adhesion of microstructured features to the substrate and then preferentially removed (by, e.g., chemical etching, etc.) after microstructured features are written. This would remove the intermediate layer everywhere except underneath the microstructured features (without affecting the substrate or microstructured features). It will be recognized that other non-conductive materials may be used for intermediate layers 116 to improve attachment of microstructured features 140 to the base surface 112. The first material 118 can be a material that is capable of undergoing multiphoton reaction by simultaneously absorbing multiple photons as described herein, or the first material 118 may not be a material that is capable of undergoing multiphoton reaction by simultaneously absorbing multiple photons as described herein. It can be desirable to choose the intermediate layer 116 so as to be compatible with the first material 118 being used.

The first material 118 can be supplied on the substrate 100 (and any intervening layers such as, e.g., optional electrically conductive layer 114, optional intermediate layer 116, etc.) using any method. Higher viscosity first materials may, for example, be coated on a substrate using any coating method that may be desirable in particular situation. For example, the first material could, in one or more embodiments, be coated on a substrate by flood coating. Other exemplary coating methods include knife coating, notch coating, reverse roll coating, gravure coating, spray coating, bar coating, spin coating and dip coating.

The first material 118 is, in one or more embodiments of the methods described herein, selectively exposed to an incident light having sufficient intensity to cause simultaneous absorption of multiple photons by the first material in the exposed region. The exposure can be accomplished by any method that is capable of providing light with sufficient intensity. Exemplary exposure methods and apparatus are described in U.S. Patent Application Publication US 2009/0099537 (“Process For Making Microneedles, Microneedle Arrays, Masters, And Replication Tools”).

After selective exposure of the first material 118 to define a microstructured pattern in the first material, the exposed first material is placed in a solvent to dissolve regions of higher solvent solubility. Exemplary solvents that can be used for developing the exposed first material may include, e.g., aqueous solvents such as, for example, water (for example, having a pH in a range of from 1 to 12) and miscible blends of water with organic solvents (for example, methanol, ethanol, propanol, acetone, acetonitrile, dimethylformamide, N-methylpyrrolidone, and the like, and mixtures thereof); and organic solvents. Exemplary useful organic solvents include alcohols (for example, methanol, ethanol, and propanol), ketones (for example, acetone, cyclopentanone, and methyl ethyl ketone), aromatics (for example, toluene), halocarbons (for example, methylene chloride and chloroform), nitriles (for example, acetonitrile), esters (for example, ethyl acetate and propylene glycol methyl ether acetate), ethers (for example, diethyl ether and tetrahydrofuran), amides (for example, N-methylpyrrolidone), and the like, and mixtures thereof.

FIG. 4 is a schematic side-view of a microstructured pattern formed in the first material 118 of FIG. 3. As discussed above, the first material 118 that does not form a part of the microstructured pattern has been removed. The microstructured pattern that remains after removal of the first material 118 includes microstructured features 140, both of which are, in the depicted embodiment, located on the base surface 112 (although in the depicted embodiment, the microstructured features 140 are located directly on the intermediate layer 116 which, itself, is located on the base surface 112 formed by electrically conductive layer 114). If, for example, the microstructured pattern formed by microstructured features 140 is to be used to construct a nozzle structure, the microstructured features 140 may, for example, correspond to nozzle through-holes in any such nozzle structure.

Each of the microstructured features in a microstructured pattern as used in connection with the methods described herein may extend away from the base surface 112 and include a base 142 proximate the base surface 112 and a distal end 144 located distal from the base surface 112. As discussed herein, the surface surrounding the base 142 of each of the microstructured features 140 in a microstructured pattern as used in connection with the methods described herein is preferably electrically conductive such that electroformed metal deposits selectively on the surface surrounding the base 142 of each of the microstructured features 140.

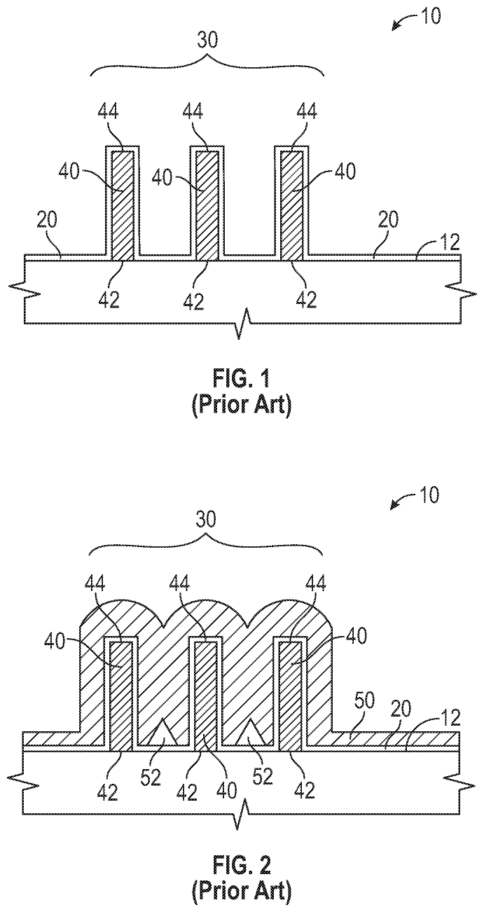

Furthermore, each of the microstructured features includes an electrically nonconductive surface between its base and distal ends such that electroformed metal does not deposit directly on the microstructured features 140. This is in direct contrast with the methods described in, e.g., U.S. Pat. No. 9,333,598 B2 and US Patent Application Publication No. US 2013/0313339 in which the microstructured pattern itself is seeded with an electrically conductive layer or otherwise provided with an electrically conductive surface on which electroformed metal deposits during the electroforming process (such as, e.g., the microstructured features 40 depicted in FIGS. 1 and 2).

Although the surfaces of the microstructured features 140 of the microstructured pattern are not themselves electrically conductive, electroforming a metal structure (e.g., in the form of a plate, three-dimensional structure, etc.) from the base surface upwards after forming the microstructured pattern results in the metal structure extending away from the base surface 112, but conforming to the electrically nonconductive surfaces of each of the microstructured features 140 while reducing or eliminating the formation of voids between the microstructured features (such as, e.g., voids 52 described in connection with FIGS. 1 and 2).

Potentially useful methods of electroforming metal structures on electrically conductive surfaces may be described in, e.g., U.S. Pat. No. 9,333,598 B2 and US Patent Application Publication No. US 2013/0313339. The metals used for electroforming may be, e.g., elemental or alloyed metals (e.g., Ni, Co, and alloys that include one or both of these metals).

In one or more embodiments of the methods described herein, the microstructured features of microstructured patterns have a non-uniform cross-section. As used herein, “non-uniform cross-section” (and variations thereof) means that the cross-section of the microstructured feature changes in shape and/or size when moving along the length of the microstructured feature between its base and distal end. The cross-sections of the microstructured feature are taken in planes that are generally transverse to a length of the microstructured feature. The length of microstructured feature is defined along an axis that extends through the microstructured feature from its base end to its distal end (which, in one or more embodiments, may result in an axis that is in the form of a curved line to stay within the microstructured feature from its base end to its distal end).

In one or more embodiments of the methods described herein, the microstructured features in a microstructured pattern may include one or more pairs of neighboring microstructured features. The neighboring pairs of microstructured features may be described as having an inter-feature distance between the microstructured features that changes when moving in a direction away from the base surface towards the distal ends of the microstructured features. Moving in a direction away from the base surface toward the distal ends of the microstructured features results, in the exemplary embodiment depicted in, e.g., FIG. 4, moving in the general direction of the Z axis.

The inter-feature distance is measured in a distance generally transverse to the lengths of the microstructured features. In the context of the exemplary embodiment depicted in FIG. 4, the inter-feature distance is measured between the depicted pair of neighboring microstructured features 140 in the direction generally illustrated by the maximum distance (dmax) between the microstructured features 140 (see FIGS. 4 and 5) and the minimum distance (dmin) between the microstructured features 140 (see FIG. 5). In one or more embodiments of methods of manufacturing microstructured articles with microstructured features of microstructured patterns that have an inter-feature distance that changes when moving in a direction away from the base surface toward the distal ends of neighboring pairs of the microstructured features. In one or more embodiments, the inter-feature distance may increase when moving away from the base surface toward the distal ends. In one or more alternative embodiments, the inter-feature distance may decrease when moving away from the base surface toward the distal ends. In still other alternative embodiments, the inter-feature distance both increases and decreases when moving in a direction away from the base surface toward the distal ends of the microstructured features.

In one or more embodiments of the methods of manufacturing microstructured articles as described herein, the microstructured features of the microstructured patterns of the microstructured articles may have a relatively limited or low height. This may be particularly true is used to manufacture nozzle structures for use in, e.g., fuel injector nozzles. In one or more exemplary embodiments, the height (h) of the microstructured features above a base surface on which the microstructured features are located (see, e.g., height (h) of microstructured features 40 above base surface 112 in FIG. 4) may be, e.g., 2 mm or less, 1.5 mm or less, 1.2 mm or less, 1 mm or less, 800 μm or less, 500 μm or less, 200 μm or less, or 100 μm or less. At the opposite end of the height range, the microstructured features of the microstructured patterns on microstructured articles manufactured using one or more embodiments of the methods described herein may have a height (h) of 5 μm or more, 10 μm or more, 20 μm or more, 30 μm or more, 40 μm or more, or 50 μm or more. When referring to the height of a pair of neighboring microstructured features having different heights, the height of the neighboring pair is based on the height of the shorter microstructured feature of the neighboring pair.

In one or more embodiments of methods of manufacturing microstructured articles with neighboring pairs of microstructured features in a microstructured pattern, at least one neighboring pair of microstructured features has an intermediate inter-feature distance (dint) measured at a distance of half the height (h) of the pair of neighboring microstructured features above the base surface. In one or more embodiments, a ratio of the height (h) of the microstructured features to the intermediate inter-feature distance (dint) may be 2:1 or more, 5:1 or more; or 10:1 or more. At the upper end, a ratio of the height (h) of the microstructured features to the intermediate inter-feature distance (dint) for one or more embodiments may be 300:1 or less, 250:1 or less, 200:1 or less, 150:1 or less, 120:1 or less, 100:1 or less, 80:1 or less, 50:1 or less, 20:1 or less, or 10:1 or less.

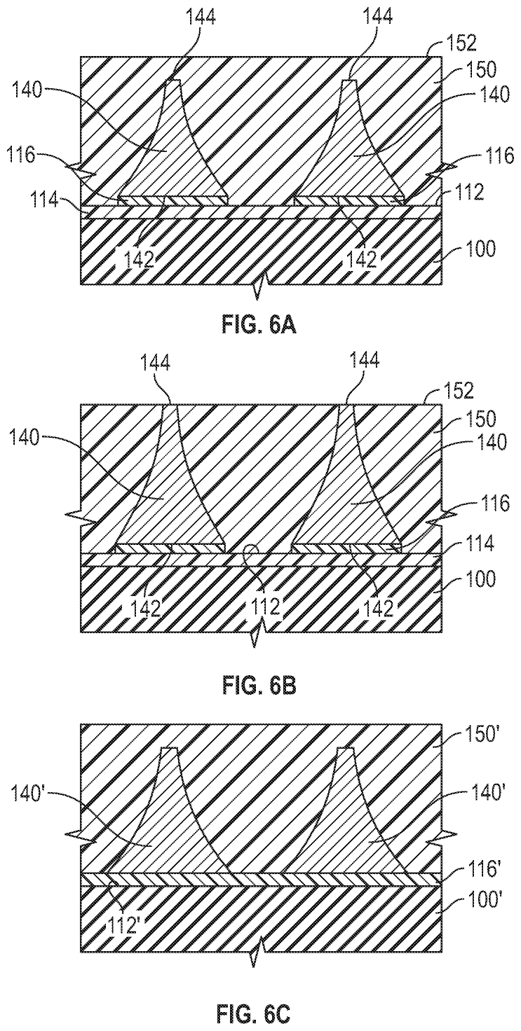

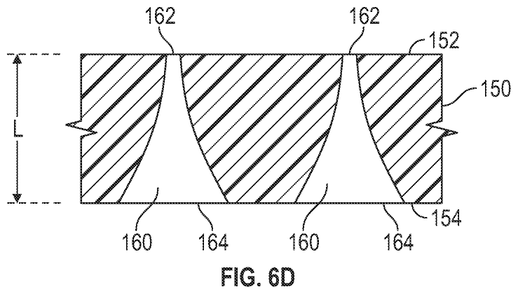

FIGS. 6A-6D depict one exemplary method of electroforming a metal structure to form a microstructured metallic article in the form of a negative of the microstructured pattern depicted in FIGS. 4 and 5. For this and the following exemplary embodiments, the metal structure is shown and described as a metal plate. It is understood, however, that other structures (e.g., three-dimensional structures) could also be made with these and other embodiments. In FIG. 6A, only the portion of the intermediate layer 116 located between the bases 142 of the microstructured features 140 and the base surface 112 remain after removal of the portion of the intermediate layer 116 that is not located between the bases 142 of the microstructured features and the base surface 112.

Removal of the portion of the intermediate layer 116 that is not located between the microstructured features 140 and the base surface 112 may be accomplished before or after forming the microstructured features 140. It may, however, be preferred and/or easier to remove the second portion of the intermediate layer 116 after forming the microstructured features 140 of the microstructured pattern.

FIG. 6A also depicts the microstructured article of FIGS. 4 and 5 after electroforming a metal plate 150 on the base surface 112 provided by the electrically conductive layer 114. As discussed above in connection with the microstructured pattern depicted in FIGS. 4 and 5, the surfaces of the microstructured features 140 are not electrically conductive and, as a result, the electroformed metal preferentially deposits on the base surface 112 provided by the electrically conductive layer 114. Furthermore, the electroformed metal plate 150 conforms to the shape of the microstructured features 140 as it is being deposited. As depicted in FIG. 6A, the electroformed metal plate 150 may be formed with a depth sufficient to cover the distal ends 144 of the microstructured features 140. As seen in, e.g., FIG. 6A, the electroformed metal plate 150 has an upper surface 152 located above the distal ends 144 of the microstructured features 140.

FIG. 6B depicts the microstructured article of FIG. 6A after removing a portion of the electroformed metal plate 150 such that the upper surface 152 is closer to the base surface 112 and, in the depicted embodiment, the distal ends 144 of the microstructured features 140 are exposed on the upper surface 152 of the electroformed metal plate 150. Removal of a portion of the electroformed metal plate 150 at its upper surface 152 may, in in one or more embodiments, result in removal of at least a portion of the first material forming the microstructured features 140 and their distal ends 144. In one or more embodiments of the methods described herein, a portion of the electroformed metal plate 150 starting on the surface 152 may be removed by any suitable technique or combination of techniques, e.g., grinding, milling, electron discharge machining (EDM), or other processes.

In one or more embodiments such as that depicted in, e.g., FIG. 6B, the surface 152 of the electroformed metal plate 150 is preferably at or below the level of the distal ends 144 of the microstructured features 140 after removal of a portion of the electroformed metal plate 150.

With reference to FIG. 6C, one or more alternative embodiments of an electrically conductive base surface 112′, whether formed by an optional electrically conductive layer provided on the substrate 100′ or by the substrate 100′ itself when the substrate 100′ is electrically conductive (as depicted in FIG. 6C), may have one or more undesirable properties. For example, an electroformed structure such as metal plate 150′ formed on the microstructured features 140′ (similar to metal plate 150 depicted and described in connection with FIG. 6A) may not release cleanly or easily from the conductive base surface 112′.

In such embodiments, the optional intermediate layer 116′ is provided on the conductive base surface 112′ formed by substrate 100′ (although the intermediate layer 116′ could be provided on an electrically conductive layer such as, e.g., layer 114 described in connection with FIG. 6A, if provided). The optional intermediate layer 116′ may be provided to improve the release characteristics of the electroformed metal plate 150′ from the conductive base surface 112′. As seen in FIG. 6C, the optional intermediate layer 116′ located between the microstructured features 140′ on the base surface 112′ would not be removed before electroforming, but would, instead, remain underneath the electroformed metal plate 150′ to, e.g., promote removal of the electroformed metal plate 150′.

In one or more embodiments, intermediate layers provided on electrically conductive layers such as intermediate layer 116′ on conductive base surface 112′ to improve the release of an electroformed metal plate 150′ may take a variety for forms. Where, for example, the electrically conductive surface 112′ is stainless steel, the intermediate layer 116′ may be formed by a passivation process/method or surface treatment. In one or more embodiments the process may involve cleaning the metal forming the base surface in a degreasing solution and then placing the metal base surface into an acid solution/bath. The acid bath may be, e.g., a nitric acid solution with or without sodium dichromate, sodium dichromate, a citric acid solution, etc. Volume % of the acid is dependent on metal base surface being passivated, as well as, e.g., temperature and/or time in the bath. In one or more embodiments in which the base surface is, e.g., stainless steel, the process removes surface contaminants and free iron to allow for the very thin oxide layer, which naturally forms when exposed to air, to form over the surface.

FIG. 6D depicts one embodiment of a microstructured metallic article that may be formed by the electroformed metal plate 150 after removal of the electroformed metal plate 150 from the substrate 100 and its optional electrically conductive layer 114 as well as removal of the first material forming the microstructured features 140 as seen in FIG. 6B. Removal of the first material forming the microstructured features 140 results in formation of cavities 160 in the first generation mold with the cavities 160 extending between the surfaces 152 and 154 on opposite sides of the electroformed metal plate 150. Each of the cavities 160 may preferably include an opening 162 on surface 152 of the microstructured metallic article formed by metal plate 150 and an opening 164 on surface 154 of the microstructured metallic article formed by metal plate 150.

In one or more embodiments of the methods described herein, the microstructured metallic article formed by electroformed metal plate 150 may be described as having a first major surface 152 and a second major surface 154, where the first and second major surfaces are located on opposite sides of the microstructured metallic article. Furthermore, the cavities 160 formed in the microstructured metallic article formed by electroformed metal plate 150 may be described as through-holes 160 extending from the first major surface 152 to the second major surface 154, wherein each through-hole 160 has a first opening 162 on the first major surface 152 and a second opening 164 on the second major surface 154. Each through-hole 160 and its first and second openings 162 and 164 have a shape defined by one microstructured feature 140 of the microstructured pattern depicted in, e.g., FIGS. 4 and 5.

In one or more embodiments of the methods described herein, the through-holes 160 in the microstructured metallic article formed in the electroformed metal plate, or other structure, may have a length L as seen in FIG. 6D, where the length L is measured from the first opening 162 to the second opening 164. The length L of the through-holes may, in one or more embodiments of the methods described herein be, e.g., 2 mm or less, 1.5 mm or less, 1.2 mm or less, 1 mm or less, 800 μm or less, 500 μm or less, 200 μm or less, or 100 μm or less. At the opposite end of the height range, the length L of the though-holes may be 5 μm or more, 10 μm or more, 20 μm or more, 30 μm or more, 40 μm or more, or 50 μm or more.

In one or more embodiments of the methods described herein, the microstructured metallic article provided by electroformed metal plate 150 (depicted in, e.g., FIG. 6D) may itself be used as a microstructured article. For example, the microstructured metallic article may be used as, e.g., a nozzle structure in a fuel injection nozzle. It may, however, be advantageous to use the microstructured metallic article provided by the electroformed metal plate 150 as depicted in FIG. 6A as a master mold to manufacture second generation molds that may be used to form finished products of any suitable material using one or more known replication processes. One potentially suitable replication process that may use the metal plate 150 as depicted in FIG. 6A as a master mold is injection molding, where, for example, the mold plate 150 of FIG. 6A is injected with an injection-moldable polymer that is removed and used to form additional metal structures having the same shape as metal plate 150 depicted in FIG. 6A.

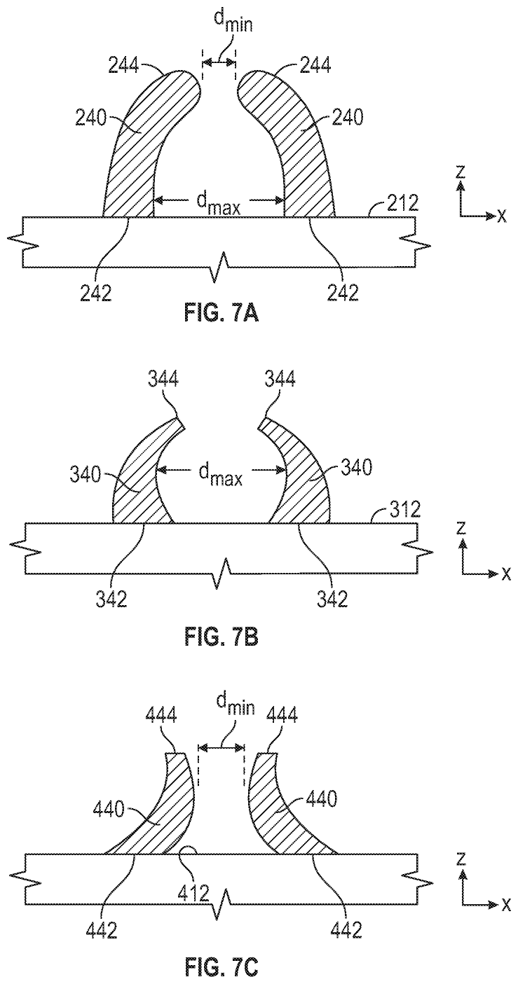

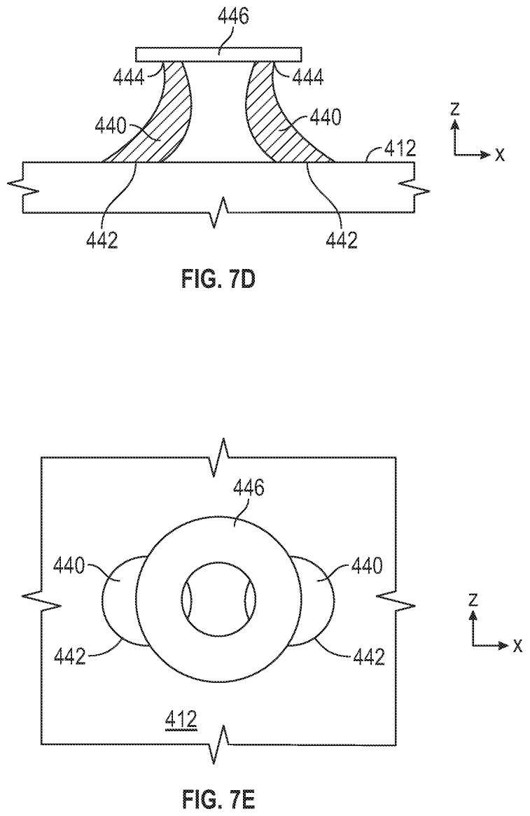

A variety of exemplary neighboring pairs of microstructured features are depicted in FIGS. 7A-7C to illustrate variations in the shape and inter-feature distances between the neighboring pairs of microstructured features that may be found in one or more embodiments of microstructured articles manufactured using one or more embodiments of methods described herein.

The neighboring pair of microstructured features 240 depicted in FIG. 7A each include a base 242 and a distal end 244. The base 242 is located proximate a base surface 212. One difference between the neighboring pair of microstructured features 240 in FIG. 7A as compared to the neighboring pair of microstructured features 140 depicted in FIGS. 4 and 5 is that the maximum distance (dmax) between the neighboring pair of microstructured features 240 is located closer to the base surface 212 than the minimum distance (dmin) between the neighboring pair of microstructured features 240.

The neighboring pair of microstructured features 340 depicted in FIG. 7B each include a base 342 and a distal end 344. The base 342 is located proximate a base surface 312. One difference between the neighboring pair of microstructured features 340 in FIG. 7B as compared to the neighboring pair of microstructured features 140 depicted in FIGS. 4 and 5 is that the maximum distance (dmax) between the neighboring pair of microstructured features 240 is located at an intermediate location between the bases 342 and the distal ends 344 of the microstructured features 340. This is in contrast to the location of the maximum distance (dmax) at the distal ends 144 of the microstructured features 140 depicted in FIG. 4 and the location of the maximum distance (dmax) at the bases 242 of the microstructured features 240 depicted in FIG. 7A.

The microstructured features 440 of the neighboring pair of microstructured features 440 depicted in FIG. 7C each include a base 442 and a distal end 444. The bases 442 are located proximate the base surface 412. One difference between the neighboring pair of microstructured features 440 in FIG. 7C as compared to the neighboring pair of microstructured features 140 depicted in FIGS. 4 and 5 is that the minimum distance (dmin) between the neighboring pair of microstructured features 440 is located at an intermediate location between the bases 442 and the distal ends 444 of the microstructured features 440. This is in contrast to the location of the minimum distance (dmin) at the bases 142 of the microstructured features 140 depicted in FIG. 4 and the location of the minimum distance (dmin) proximate the distal ends 244 of the microstructured features 240 depicted in FIG. 7A.

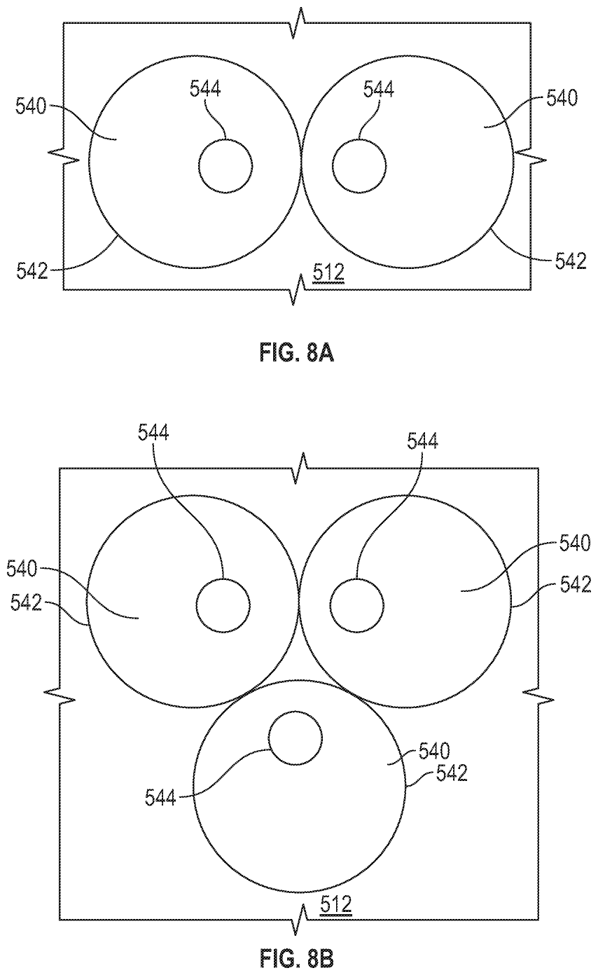

FIGS. 7D and 7E depict another optional feature that may be found in one or more embodiments of a microstructured pattern of microstructured features in connection with the microstructured features of FIG. 7C. The microstructured features 440 of the illustrative embodiment of neighboring pair of microstructured features 440 depicted in FIGS. 7D and 7E are interconnected to each other. In particular, the microstructured features 440 are interconnected to each other through a support structure 446 to which the distal ends 444 of the microstructured features are attached. The depicted illustrative embodiment of microstructured features depicted in FIGS. 7D and 7E represents only one embodiment of interconnected microstructured features. Alternative examples of interconnected microstructured features of microstructured patterns as described herein may include, but are not limited to, microstructured features interconnected directly to each other at one or more intermediate locations between the base and distal ends of the microstructured features (e.g., in the absence of a separate feature such as support structure 446), microstructured features interconnected directly to each other at the bases of the microstructured features (see, e.g., microstructured features 540 of FIGS. 8A and 8B), etc.

Another manner in which one or more embodiments of the methods of manufacturing microstructured articles as described herein may be characterized is in the size of the bases of microstructured features in the microstructured pattern on the microstructured articles. For example, in one or more embodiments, the base of each microstructured feature of the microstructured pattern may occupy an area of 50 μm² or more, 60 μm² or more, 70 μm² or more, 80 μm² or more, or 100 μm² or more on the base surface on which the microstructured features are located. At an upper end, the base of each microstructured feature in a microstructured pattern may, in one or more embodiments, occupy an area of 1 mm² or less, 0.5 mm² or less, 0.2 mm² or less, 0.1 mm² or less, or 0.05 mm² or less on the base surface on which the microstructured features are located.

In one or more embodiments of the methods described herein, the base of one or more of the microstructured features forming the microstructured pattern is completely surrounded by an electrically conductive base surface. One example of such an embodiment is depicted in, e.g., FIG. 5, where the bases 142 of the microstructured features 140 are each separated from each other such that each base 142 is completely surrounded by the electrically conductive surface (after removal of any intermediate layer 116 as discussed herein).

In one or more alternative embodiments of the methods described herein, the bases of a pair of neighboring microstructured features may contact each other such that the base of neither microstructured feature of the pair of neighboring microstructured features is completely surrounded by an electrically conductive base surface. One example of such an embodiment is depicted in, e.g., FIG. 8A, where the bases 542 of the pair of neighboring microstructured features 540 meet or contact each other such that the base 542 of neither of the microstructured features 540 is completely surrounded by the electrically conductive base surface 512 on which the microstructured features 540 are located. It should also be noted that the distal ends 544 of the microstructured features 540 are not centered over the bases 542 that may be offset relative to their respective base 542.

In one or more further alternative embodiments of the methods described herein where the microstructured pattern includes three or more microstructured features 540 as depicted in, e.g., FIG. 8B, one or more of the microstructured features may have a base 542 in contact with the bases 542 of at least two other microstructured features such that the base 542 of the one or more microstructured features 540 is not completely surrounded by the electrically conductive base surface 512 on which the microstructured features 540 are located. The distal ends 544 of the microstructured features 540 are also, in this exemplary embodiment, also offset relative to their respective bases 542.

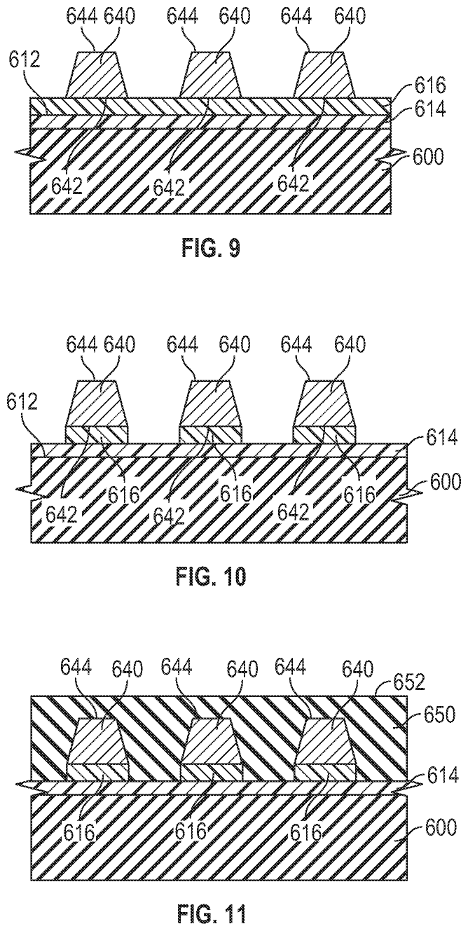

In one or more embodiments of methods of manufacturing microstructured articles as described herein, the method may include forming an intermediate layer that is not electrically conductive on the electrically conductive base surface before forming a microstructured pattern on the base surface. In such a method, the bases of the microstructured features of the microstructured pattern are formed on and cover a first portion of any such intermediate layer. One exemplary embodiment of a microstructured article including an intermediate layer on which microstructured features of a microstructured pattern are formed is depicted in FIG. 9.

The microstructured pattern depicted in FIG. 9 includes microstructured features 640, each of which includes a base 642 and a distal end 644 similar to the microstructured features described above. The microstructured features 640 are located on an intermediate layer 616 which is, in turn, located on an electrically conductive layer 614 formed on substrate 600. As discussed elsewhere herein, the electrically conductive layer 614 may be optional where, for example, the substrate 600 is, itself, electrically conductive. The intermediate layer 616 may be provided to perform a variety of functions including, for example, improving attachment of the microstructured features 640 to the substrate 600, and providing the ability to selectively expose areas of the electrically conductive base surface 612 by selectively removing the intermediate layer 616.

FIG. 10 depicts the microstructured features 640 after removal of a second portion of the intermediate layer 616 which, in the depicted embodiment, constitutes the portion of the intermediate layer surrounding the bases 642 of the microstructured features 640. As a result, only the portion of the intermediate layer 616 located between the bases 642 of the microstructured features 640 and the base surface 612 remains after removal of the second portion of the intermediate layer 616.

Removal of the second portion of the intermediate layer 616 that is not located between the microstructured features 640 and the base surface 612 may be accomplished before or after forming the microstructured features 640. It may, however, be preferred and/or easier to remove the second portion of the intermediate layer 616 after forming the microstructured features 640 of the microstructured pattern.

FIG. 11 depicts the microstructured article of FIG. 10 after electroforming a metal plate 650 on the base surface 612 provided by the electrically conductive layer 614. As discussed above in connection with the microstructured pattern depicted in FIGS. 4 and 5, the surfaces of the microstructured features 640 are not electrically conductive and, as a result, the electroformed metal deposits on the base surface 612 provided by the electrically conductive layer 614 but does not directly form on the surfaces of the microstructured features 640. The electroformed metal plate 650 does, however, preferably conform to the shape of the microstructured features 640 as it is being deposited.

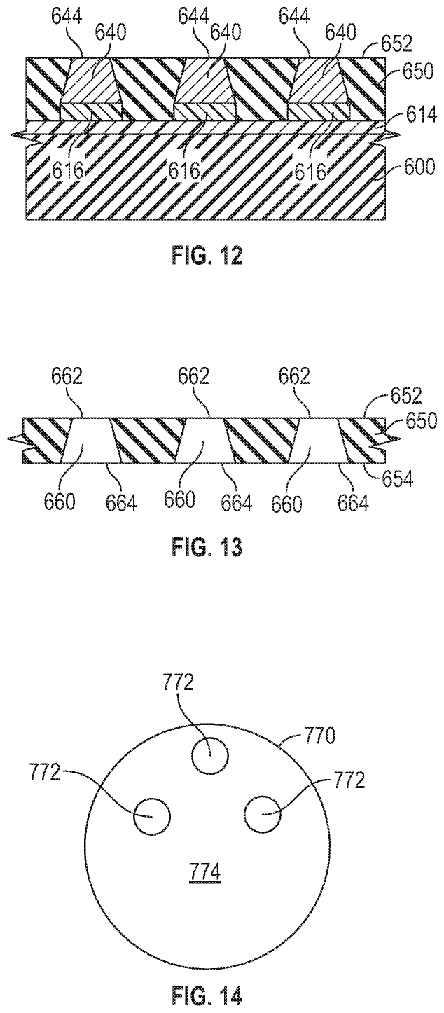

FIG. 12 depicts the microstructured article of FIG. 11 after removing a portion of the electroformed metal plate 650. In particular, the electroformed metal plate 650 is removed by machining, polishing, etc. the surface 652 of the electroformed metal plate 650 that is located above the distal ends 644 of the microstructured features 640. In one or more embodiments such as that depicted in, e.g., FIG. 12, the surface 652 of the electroformed metal plate 650 is preferably at or below the level of the distal ends 644 of the microstructured features 640 after removal of a portion of the electroformed metal plate 650.

FIG. 13 depicts one embodiment of a microstructured metallic article provided by the electroformed metal plate 650 after removal of the electroformed metal plate 650 from the substrate 600 and its optional electrically conductive layer 614 as well as the first material forming the microstructured features 640. Removal of the first material forming the microstructured features 640 results in formation of cavities 660 in the microstructured metallic article with the cavities 660 extending between the major surfaces 652 and 654 located on opposite sides of the microstructured metallic article formed by electroformed metal plate 650. Each of the cavities 660 may preferably include an opening 662 on surface 652 of the microstructured metallic article and an opening 664 on surface 654 of the microstructured metallic article.

In one or more embodiments of the methods described herein, the microstructured metallic article provided by electroformed metal plate 650 (as seen in, e.g., FIG. 13) may be used as, e.g., a nozzle structure in a fuel injection nozzle. It may, however, be advantageous to use the microstructured metallic article provided by the electroformed metal plate 650 as depicted in FIG. 11 as a master mold to manufacture second generation molds that may be used to form finished products of any suitable material using one or more known replication processes. One potentially suitable replication process that may use the metal plate 650 as depicted in FIG. 11 as a master mold is injection molding, where, for example, the metal plate 650 of FIG. 11 is injected with an injection-moldable polymer that is removed and used to form additional metal structures having the same shape as metal plate 650 depicted in FIG. 11.

One exemplary replication process with which a mold (such as, e.g., a master mold manufactured according to the process that results in the mold depicted in FIG. 11) may be used to form additional electroformed microstructured articles can be described in connection with FIGS. 14 to 21. In particular, the method depicted by the steps illustrated in FIGS. 14 to 21 can provide a process by which microstructured features can be replicated using more conventional molding techniques such as, e.g., injection molding. It should be understood, however, that the method described in connection with FIGS. 14-21 could be used with a mold manufactured by any method—not just the methods described herein.

FIG. 14 depicts one embodiment of a molding insert 770 that may be used in conjunction with a mold such as, e.g., mold 650 depicted in FIG. 11. The molding insert 770 may be formed of any suitable material or materials and includes apertures 772 formed through the molding insert 770. In one or more embodiments, the apertures 772 are preferably sized and spaced to align with cavities 660 in the mold 650 such that mold material can be passed through the apertures 772 into cavities 660 in the mold 650.

In one or more embodiments, at least the surface 774 of the molding insert 770 is an electrically conductive surface on which electroformed metal may be deposited. In one or more embodiments, the electrically conductive surface 774 may be provided in the form of a metallic layer on an otherwise nonconductive substrate forming molding insert 770. In one or more alternative embodiments, the molding insert 770 may be constructed of electrically conductive materials such that a separate electrically conductive coating is not needed to provide an electrically conductive surface 774 on the molding insert 770.

FIG. 15 depicts the mold 650 with a major surfaced 654 positioned against surface 774 of the molding insert 770 such that apertures 772 in the molding insert 770 are aligned with openings 664 in cavities 660 in mold 650.

With the mold 650 and molding insert 770 thus positioned, molding material 680 may be delivered into the cavities 660 in the mold 650 as depicted in, e.g., FIG. 16. The molding material 680 may be delivered into the cavities 660 through the apertures 772 and openings 664 aligned with the apertures 772.

After delivery of the molding material 680 into the cavities 660, the mold 650 may be removed from the molding material 680 filling cavities 660 as well as molding insert 770. One exemplary embodiment of the resulting structure is depicted in FIG. 17. As depicted there, molding material 680 forms a microstructured pattern of microstructured features 740 that replicate the shape of cavities 660 in mold 650 and extend away from the base surface 774 provided on molding insert 770. As discussed herein, the microstructured features 740 are preferably nonconductive while the surface 774 on molding insert 770 is electrically conductive.

The microstructured features 740 formed by this method may have any of the characteristics of the other microstructured features of microstructure patterns as described herein with respect to, e.g., shape, size, spacing, etc.

FIG. 18 depicts the microstructured article of FIG. 17 after electroforming a metal plate 750 on the electrically conductive surface 774 of the molding insert 770. As discussed above in connection with the microstructured patterns depicted in the other exemplary embodiments described herein, the surfaces of the microstructured features 740 are not electrically conductive and, as a result, the electroformed metal preferentially deposits on the electrically conductive surface 774. Furthermore, the electroformed metal plate 750 conforms to the shape of the microstructured features 740 as it is being deposited. As depicted in FIG. 18, the electroformed metal plate 750 may be formed with a depth sufficient to cover the distal ends 744 of the microstructured features 740. As seen in, e.g., FIG. 18, the electroformed metal plate 750 has an upper surface 752 located above the distal ends 744 of the microstructured features 740.

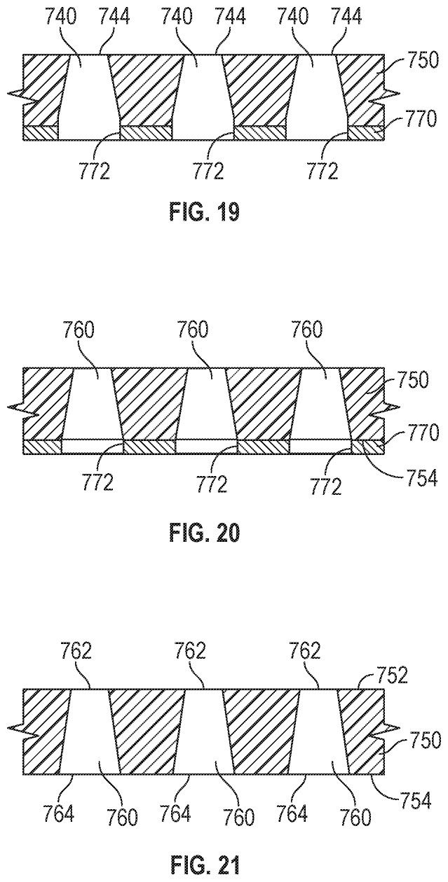

FIG. 19 depicts the microstructured article of FIG. 18 after removing a portion of the electroformed metal plate 750 such that the upper surface 752 is closer to the molding insert 770 and, in the depicted embodiment, the distal ends 744 of the microstructured features 740 are exposed on the upper surface 752 of the electroformed metal plate 750. Removal of a portion of the electroformed metal plate 750 at its upper surface 752 may, in in one or more embodiments, result in removal of at least a portion of the molding material forming the microstructured features 740 and their distal ends 744. In one or more embodiments of the methods described herein, a portion of the electroformed metal plate 750 starting on the surface 752 may be removed by any suitable technique or combination of techniques, e.g., grinding, milling, electron discharge machining (EDM), or other processes.

In one or more embodiments such as that depicted in, e.g., FIG. 19, the surface 752 of the electroformed metal plate 750 is preferably at or below the level of the distal ends 744 of the microstructured features 740 after removal of a portion of the electroformed metal plate 750.

FIG. 20 depicts one embodiment of a microstructured metallic article that may be formed by the electroformed metal plate 750 after removal of the molding material forming the microstructured features 740. Removal of the molding material forming the microstructured features 740 results in formation of cavities 760 in the electroformed metal plate 750 with the cavities 760 extending between the major surfaces 752 and 754 on opposite sides of the electroformed metal plate 750 as well as through the apertures 772 in the molding insert 770.

In one or more embodiments of the methods described herein, the microstructured metallic article formed by electroformed metal plate 750 may be completed and include the molding insert 770. In other words, in one or more methods as described herein, the molding insert 770 may form a part of any finished article.

In one or more alternative embodiments, the method may further include removal of the molding insert 770, with one exemplary embodiment of a resulting microstructured metallic article formed by electroformed metal plate 750 being depicted in FIG. 21. The microstructured metallic article formed by electroformed metal plate 750 may be described as having a first major surface 752 and a second major surface 754, where the first and second major surfaces are located on opposite sides of the microstructured metallic article. Furthermore, the cavities 760 formed in the microstructured metallic article formed by electroformed metal plate 750 may be described as through-holes 760 extending from the first major surface 752 to the second major surface 754, wherein each through-hole 760 has a first opening 762 on the first major surface 752 and a second opening 764 on the second major surface 754. Each through-hole 760 and its first and second openings 762 and 764 have a shape defined by one microstructured feature 740 of the microstructured pattern depicted in, e.g., FIG. 19.

### Illustrative Embodiments

1. A method of fabricating a microstructured metallic article, the method comprising:

forming a microstructured pattern of a first material, wherein the microstructured pattern comprises a plurality of microstructured features extending away from a base surface, each microstructured feature of the plurality of microstructured features comprises a base proximate the base surface and a distal end located distal from the base surface, wherein the base surface is an electrically conductive surface, each microstructured feature has a non-uniform cross-section along its length and an electrically non-conductive surface between its base and distal end, and the plurality of microstructured features of the microstructured pattern are (i) discrete from each other, (ii) connected to each other, or (iii) a combination of both (i) and (ii);

electroforming a metal structure (e.g., in the form of a plate, three-dimensional structure, etc.) from the base surface after forming the microstructured pattern, wherein the metal structure extends away from the base surface and conforms to the electrically non-conductive surface of each microstructured feature; and

removing the first material from the metal structure to make a microstructured metallic article comprising a negative of the microstructured pattern in the metal structure. The metal structure can be suitable for making a nozzle structure such as, e.g., a nozzle plate, a combination nozzle plate and valve guide structure, etc.
2. A method according to embodiment 1, wherein the plurality of microstructured features comprises a pair of neighboring microstructured features comprising a first microstructure and a second microstructure, wherein a distance between the first microstructure and the second microstructure changes when moving in a direction away from the base surface towards the distal ends of the first and second microstructured features.
3. A method according to embodiment 2, wherein the distance increases.
4. A method according to embodiment 2, wherein the distance decreases.
5. A method according to embodiment 2, wherein the distance increases and decreases when moving in a direction away from the base surface towards the distal ends of the first and second microstructured features.
6. A method according to any one of embodiments 2 to 5, wherein the pair of neighboring microstructured features comprise a height above the base surface and an intermediate inter-feature distance between the pair of neighboring microstructured features, wherein the intermediate inter-feature distance is measured at a distance of half the height of the pair of neighboring microstructured features above the base surface, and wherein a ratio of the height to the intermediate inter-feature distance is 2:1 or more, 5:1 or more; or 10:1 or more. At the upper end, a ratio of the height of the microstructured features to the intermediate inter-feature distance is 300:1 or less, 250:1 or less, 200:1 or less, 150:1 or less, 120:1 or less, 100:1 or less, 80:1 or less, 50:1 or less, 20:1 or less, or 10:1 or less.
7. A method according to any one of embodiments 1 to 6, wherein the base of each microstructure of the plurality of microstructured features is completely surrounded by the electrically conductive base surface.
8. A method according to any one of embodiments 1 to 6, wherein the bases of the pair of neighboring microstructured features contact each other such that the base of neither microstructure of the pair of neighboring microstructured features is completely surrounded by the electrically conductive base surface.
9. A method according to any one of embodiments 1 to 6, wherein the plurality of microstructured features comprises three or more microstructured features, and wherein at least one microstructure of the three or more microstructured features comprises a base in contact with the bases of at least two microstructured features such that the base of at least one microstructure is not completely surrounded by the electrically conductive base surface.
10. A method according to any one of embodiments 1 to 9, wherein an entire surface of each microstructure of the plurality of microstructured features is electrically non-conductive.
11. A method according to any one of embodiments 1 to 10, wherein the method further comprises forming an intermediate layer on the base surface before forming the microstructured pattern on the base surface, wherein the bases of the plurality of microstructured features are formed on and cover a first portion of the intermediate layer.
12. A method according to embodiment 11, wherein the method further comprises removing a second portion of the intermediate layer before forming the microstructured pattern on the base surface.
13. A method according to embodiment 12, wherein the method further comprises removing a second portion of the intermediate layer after forming the microstructured pattern.
14. A method according to any one of embodiments 1 to 13, wherein the base surface comprises a surface of a monolithic base article.
15. A method according to any one of embodiments 1 to 13, wherein the base surface comprises an electrically conductive layer.
16. A method according to embodiment 15, wherein the electrically conductive layer is located on an electrically non-conductive substrate.
17. A method according to any one of embodiments 1 to 16, wherein a height of each microstructured feature of the plurality of microstructured features above the base surface is 2 millimeters or less, 1.5 mm or less, 1.2 mm or less, 1 mm or less, 800 μm or less, 500 μm or less, 200 μm or less, or 100 μm or less. At the opposite end of the height range, the microstructured features have a height (h) of 5 μm or more, 10 μm or more, 20 μm or more, 30 μm or more, 40 μm or more, or 50 μm or more.
18. A method according to any one of embodiments 1 to 17, wherein the base of each microstructured feature of the plurality of microstructured features occupies an area of 1 mm² or less, 0.5 mm² or less, 0.2 mm² or less, 0.1 mm² or less, or 0.05 mm² or less on the base surface. At a lower end, the base of each microstructured feature in a microstructured pattern occupy an area of 50 μm² or more, 60 μm² or more, 70 μm² or more, 80 μm² or more, or 100 μm² or more on the base surface.
19. A method according to any one of embodiments 1 to 18, wherein the microstructured metallic article comprises first and second major surfaces on opposite sides of the microstructured metallic article, wherein the microstructured metallic article comprises a plurality of through-holes extending from the first major surface to the second major surface, wherein each through-hole comprises a first opening on the first major surface and a second opening on the second major surface, and wherein each through-hole of the plurality of through-holes and its first and second openings have a shape defined by one microstructure of the plurality of microstructured features.
20. A method according to embodiment 19, wherein each through-hole of the plurality of through-holes in the microstructured metallic article has a length measured from the first opening to the second opening of 2 millimeters or less, 1.5 mm or less, 1.2 mm or less, 1 mm or less, 500 μm or less, 200 μm or less, or 100 μm or less. At the opposite end of the height range, the through-holes have a length of 5 μm or more, 10 μm or more, 20 μm or more, 30 μm or more, 40 μm or more, or 50 μm or more.
21. A method according to any one of embodiments 1 to 20, wherein forming the microstructured pattern of the first material comprises providing an amount (e.g., in the form of a layer or thickness) of the first material over the base surface followed by using a multiphoton process on the first material.
22. A method according to embodiment 21, wherein the first material comprises poly(methyl methacrylate).
23. The method of any one of embodiments 21 to 22, wherein forming the microstructured pattern comprises a two photon reaction in the first material.
24. The method of any one of embodiments 21 to 23, wherein forming the microstructured pattern comprises delivering energy to the first material using a two photon process.
25. The method of any one of embodiments 21 to 24, wherein forming the microstructured pattern in the first material comprises exposing at least a portion of the first material to cause a simultaneous absorption of multiple photons.
26. The method of embodiment 25, wherein forming the microstructured pattern in the first material comprises removing the exposed portions of the first material.
27. The method of embodiment 25, wherein forming the microstructured pattern in the first material comprises removing the unexposed portions of the first material.
28. A method of fabricating a microstructured metallic article, the method comprising:

positioning an electrically conductive surface of a molding insert against a first major surface of a microstructured mold, wherein the microstructured mold comprises a second major surface on an opposite side of the microstructured mold from the first major surface, wherein the microstructured metallic mold comprises a plurality of cavities located therein, wherein each cavity of the plurality of cavities comprises a first opening on the first major surface, wherein the molding insert comprises a plurality of apertures, wherein each aperture of the plurality of apertures is aligned with a first opening of one of the cavities in the microstructured mold;

delivering molding material into each cavity of the plurality of cavities of the microstructured mold;

separating the microstructured mold from the molding material and the molding insert after delivering molding material into each cavity of the plurality of cavities of the microstructured mold, wherein the molding material forms a microstructured pattern comprising a plurality of microstructured features extending away from the electrically conductive surface of the molding insert, wherein each microstructured feature of the plurality of microstructured features comprises a base proximate the electrically conductive surface of the molding insert and a distal end located distal from the electrically conductive surface of the molding insert, and wherein each microstructured feature has an electrically non-conductive surface between its base and distal end;

electroforming a metal structure on the electrically conductive surface of the molding insert after separating the microstructured mold from the molding material and the molding insert, wherein the metal structure extends away from the electrically conductive surface of the molding insert and conforms to the electrically non-conductive surface of each microstructured feature; and

removing the molding material from the metal structure to make a microstructured metallic article comprising a negative of the microstructured pattern in the metal structure.
29. A method according to embodiment 28, wherein each aperture of the plurality of apertures aligned with a first opening of one of the cavities in the microstructured mold is equal to or larger than the first opening.
30. A method according to any one of embodiments 28 to 29, wherein delivering molding material into each cavity of the plurality of cavities of the microstructured mold comprises passing the molding material through the plurality of apertures in the molding insert.
31. A method according to embodiment 30, wherein the molding material passes through the plurality of apertures in the molding insert before reaching the plurality of cavities in the microstructured mold.
32. A method according to any one of embodiments 28 to 31, wherein each microstructured feature of the plurality of microstructured features comprises a non-uniform cross-section along its length, and wherein the plurality of microstructured features of the microstructured pattern are (i) discrete from each other, (ii) connected to each other, or (iii) a combination of both (i) and (ii).
33. A method according to any one of embodiments 28 to 32, wherein the plurality of microstructured features comprises a pair of neighboring microstructured features comprising a first microstructure and a second microstructure, wherein a distance between the first microstructure and the second microstructure changes when moving in a direction away from the molding insert towards the distal ends of the first and second microstructured features.
34. A method according to embodiment 33, wherein the distance increases.
35. A method according to embodiment 33, wherein the distance decreases.
36. A method according to embodiment 33, wherein the distance increases and decreases when moving in a direction away from the molding insert towards the distal ends of the first and second microstructured features.
37. A method according to any one of embodiments 28 to 36, wherein the pair of neighboring microstructured features comprise a height above the electrically conductive molding insert and an intermediate inter-feature distance between the pair of neighboring microstructured features, wherein the intermediate inter-feature distance is measured at a distance of half the height of the pair of neighboring microstructured features above the electrically conductive surface of the molding insert, and wherein a ratio of the height to the intermediate inter-feature distance is 2:1 or more, 5:1 or more; or 10:1 or more. At the upper end, a ratio of the height of the microstructured features to the intermediate inter-feature distance is 300:1 or less, 250:1 or less, 200:1 or less, 150:1 or less, 120:1 or less, 100:1 or less, 80:1 or less, 50:1 or less, 20:1 or less, or 10:1 or less.
38. A method according to any one of embodiments 28 to 37, wherein the base of each microstructure of the plurality of microstructured features is completely surrounded by the electrically conductive surface of the molding insert.
39. A method according to any one of embodiments 28 to 38, wherein an entire surface of each microstructure of the plurality of microstructured features is electrically non-conductive.
40. A method according to any one of embodiments 28 to 39, wherein the electrically conductive surface of the molding insert comprises an electrically conductive layer on a substrate.
41. A method according to embodiment 40, wherein the substrate is not electrically conductive.
42. A method according to any one of embodiments 28 to 41, wherein a height of each microstructured feature of the plurality of microstructured features above the electrically conductive surface of the molding insert is 2 millimeters or less, 1.5 mm or less, 1.2 mm or less, 1 mm or less, 500 μm or less, 200 μm or less, or 100 μm or less. At the opposite end of the height range, the microstructured features have a height (h) of 5 μm or more, 10 μm or more, 20 μm or more, 30 μm or more, 40 μm or more, or 50 μm or more.
43. A method according to any one of embodiments 28 to 42, wherein each aperture of the plurality of apertures of the molding insert occupies an area of 1 mm² or less, 0.5 mm² or less, 0.2 mm² or less, 0.1 mm² or less, or 0.05 mm² or less on the electrically conductive surface of the molding insert. At a lower end, each aperture of the plurality of apertures of the molding insert occupies an area of 50 μm² or more, 60 μm² or more, 70 μm² or more, 80 μm² or more, or 100 μm² or more on the electrically conductive surface of the molding insert.
44. A method according to any one of embodiments 28 to 43, wherein the microstructured metallic article comprises a replica of the microstructured mold including first and second major surfaces on opposite sides of the microstructured metallic article and a plurality of cavities, wherein each cavity comprises a first opening on the first major surface, and wherein each cavity of the plurality of cavities and its first opening have a shape defined by one microstructure of the plurality of microstructured features.
45. A method according to embodiment 44, wherein the method comprises removing the microstructured mold from the microstructured pattern before electroforming the metal structure.
46. A method according to any one of embodiments 1 to 45, further comprising removing a portion of the electroformed metal structure such that a distal end of at least one or more, most or all of the microstructured features are exposed to form an opening.

It should be understood that although the exemplary methods are described as “comprising” one or more components, features or steps, the methods may “comprise,” “consists of,” or “consist essentially of any of the above-described components and/or features and/or steps. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of or “consisting of or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a method that “comprises” a list of elements (e.g., components or features or steps) is not necessarily limited to only those elements (or components or features or steps), but may include other elements (or components or features or steps) not expressly listed or inherent to the method.

As used herein, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

Further, the term “comprises” and variations thereof do not have a limiting meaning where these terms appear in the accompanying description. Moreover, “a,” “an,” “the,” “at least one,” and “one or more” are used interchangeably herein.

As used herein, the transitional phrases “consists of and “consisting of exclude any element, step, or component not specified. For example, “consists of or “consisting of used in a claim would limit the claim to the components, materials or steps specifically recited in the claim except for impurities ordinarily associated therewith (i.e., impurities within a given component). When the phrase “consists of or “consisting of appears in a clause of the body of a claim, rather than immediately following the preamble, the phrase “consists of or “consisting of limits only the elements (or components or steps) set forth in that clause; other elements (or components) are not excluded from the claim as a whole.

As used herein, the transitional phrases “consists essentially of and “consisting essentially of are used to define a method that includes materials, steps, features, components, or elements, in addition to those literally disclosed, provided that these additional materials, steps, features, components, or elements do not materially affect the basic and novel characteristic(s) of the claimed invention. The term “consisting essentially of occupies a middle ground between “comprising” and “consisting of. Further, it should be understood that the herein-described methods may comprise, consist essentially of, or consist of any of the herein-described components and features, as shown in the figures with or without any additional feature(s) not shown in the figures. In other words, in some embodiments, the methods of the present invention may have any additional feature that is not specifically shown in the figures. In some embodiments, the methods of the present invention do not have any additional features other than those (i.e., some or all) shown in the figures, and such additional features, not shown in the figures, are specifically excluded from the methods.

The complete disclosure of the patents, patent applications, patent documents, and publications identified herein are incorporated by reference in their entirety as if each were individually incorporated. To the extent there is a conflict or discrepancy between this document and the disclosure in any such incorporated document, this document will control.

From the above disclosure of the general principles of the present invention and the preceding detailed description, those skilled in this art will readily comprehend the various modifications, re-arrangements and substitutions to which the present invention is susceptible, as well as the various advantages and benefits the present invention may provide. Therefore, the scope of the invention should be limited only by the following claims and equivalents thereof. In addition, it is understood to be within the scope of the present invention that the disclosed and claimed methods may be useful in other applications (i.e., in the manufacturing of articles other than fuel injector nozzle structures). Therefore, the scope of the invention may be broadened to include the use of the claimed and disclosed methods for such other applications.

1. A method of fabricating a microstructured metallic article, the method comprising:
forming a microstructured pattern of a first material, wherein the microstructured pattern comprises a plurality of microstructured features extending away from a base surface, wherein each microstructured feature of the plurality of microstructured features comprises a base proximate the base surface and a distal end located distal from the base surface, wherein the base surface is an electrically conductive surface, each microstructured feature has a non-uniform cross-section along its length and an electrically non-conductive surface between its base and distal end, wherein the plurality of microstructured features of the microstructured pattern are (i) discrete from each other, (ii) connected to each other, or (iii) a combination of both (i) and (ii);
electroforming a metal structure from the base surface after forming the microstructured pattern, wherein the metal structure extends away from the base surface and conforms to the electrically non-conductive surface of each microstructured feature; and
removing the first material from the metal structure to make a microstructured metallic article comprising a negative of the microstructured pattern in the metal structure.

2. A method according to claim 1, wherein the plurality of microstructured features comprises a pair of neighboring microstructured features comprising a first microstructure and a second microstructure, wherein a distance between the first microstructure and the second microstructure changes when moving in a direction away from the base surface towards the distal ends of the first and second microstructured features.

3. A method according to claim 2, wherein the distance increases.

4. A method according to claim 2, wherein the distance decreases.

5. A method according to claim 2, wherein the distance increases and decreases when moving in a direction away from the base surface towards the distal ends of the first and second microstructured features.

6. A method according to any one of claim 1, wherein the base of each microstructure of the plurality of microstructured features is completely surrounded by the electrically conductive base surface.

7. A method according to claim 1, wherein the bases of the pair of neighboring microstructured features contact each other such that the base of neither microstructure of the pair of neighboring microstructured features is completely surrounded by the electrically conductive base surface.

8. A method according to claim 1, wherein the plurality of microstructured features comprises three or more microstructured features, and wherein at least one microstructure of the three or more microstructured features comprises a base in contact with the bases of at least two microstructured features such that the base of at least one microstructure is not completely surrounded by the electrically conductive base surface.

9. A method according claim 1, wherein an entire surface of each microstructure of the plurality of microstructured features is electrically non-conductive.

10. A method according to claim 1, wherein the base surface comprises an electrically conductive layer.

11. A method according to claim 1, wherein a height of each microstructure of the plurality of microstructured features above the base surface is 2 millimeters or less.

12. A method according to claim 1, wherein the microstructured metallic article comprises first and second major surfaces on opposite sides of the microstructured metallic article, wherein the microstructured metallic article comprises a plurality of through-holes extending from the first major surface to the second major surface, wherein each through-hole comprises a first opening on the first major surface and a second opening on the second major surface, and wherein each through-hole of the plurality of through-holes and its first and second openings have a shape defined by one microstructure of the plurality of microstructured features.

13. A method according to claim 1, wherein forming the microstructured pattern of the first material comprises providing an amount of the first material over the base surface followed by using a multiphoton process on the first material.

14. A method of fabricating a microstructured metallic article, the method comprising:
positioning an electrically conductive surface of a molding insert against a first major surface of a microstructured mold, wherein the microstructured mold comprises a second major surface on an opposite side of the microstructured mold from the first major surface, wherein the microstructured metallic mold comprises a plurality of cavities located therein, wherein each cavity of the plurality of cavities comprises a first opening on the first major surface, wherein the molding insert comprises a plurality of apertures, wherein each aperture of the plurality of apertures is aligned with a first opening of one of the cavities in the microstructured mold;
delivering molding material into each cavity of the plurality of cavities of the microstructured mold;
separating the microstructured mold from the molding material and the molding insert after delivering molding material into each cavity of the plurality of cavities of the microstructured mold, wherein the molding material forms a microstructured pattern comprising a plurality of microstructured features extending away from the electrically conductive surface of the molding insert, wherein each microstructured feature of the plurality of microstructured features comprises a base proximate the electrically conductive surface of the molding insert and a distal end located distal from the electrically conductive surface of the molding insert, and wherein each microstructured feature has an electrically non-conductive surface between its base and distal end;
electroforming a metal structure on the electrically conductive surface of the molding insert after separating the microstructured mold from the molding material and the molding insert, wherein the metal structure extends away from the electrically conductive surface of the molding insert and conforms to the electrically non-conductive surface of each microstructured feature; and
removing the molding material from the metal structure to make a microstructured metallic article comprising a negative of the microstructured pattern in the metal structure.

15. A method according to claim 14, wherein each microstructured feature of the plurality of microstructured features comprises a non-uniform cross-section along its length, wherein the plurality of microstructured features of the microstructured pattern are (i) discrete from each other, (ii) connected to each other, or (iii) a combination of both (i) and (ii).

16. A method according to claim 1, further comprising removing a portion of the electroformed metal structure such that a distal end of at least one or more, most or all of the microstructured features are exposed to form an opening.
